(19) United States
(12) Patent Application Publication
(10) Pub. No.: US 2011/0109116 A1
(43) Pub. Date: May 12, 2011

(54) Ice Guard

(76) Inventor: Rebekah J. Mitchell, Milton, PA (US)

(21) Appl. No.: 12/927,250

(22) Filed: Nov. 10, 2010

Related U.S. Application Data
(60) Provisional application No. 61/281,087, filed on Nov. 12, 2009.

(51) Int. Cl. B60J 1/20

(52) U.S. Cl. 296/95.1

(57) ABSTRACT

The Ice Guard is a specially designed protective covering configured specifically to encompass the entire front windshield or rear window of a vehicle, thus protecting these areas from the elements. Generally rectangular in shape and gently contoured for a custom fit, the Ice Guard is designed to encompass the windshield completely, thus effectively preventing the accumulation of frost, ice or snow. The Ice Guard is produced in a range of sizes appropriate for the various makes and model vehicles on the market.

### CLAIM OF PRIORITY

This patent application claims priority under 35 USC 119(e) (1) from U.S. Provisional Patent Application Ser. No. 61/281,087 filed Nov. 12, 2009, of common inventorship herewith entitled, “Ice Guard.”

### FIELD OF THE INVENTION

The present invention pertains to the field of automobile covers, and more specifically to the field of automobile windshield covers.

### BACKGROUND OF THE INVENTION

The prior art has put forth several designs for automobile windshield covers. Among these are:

U.S. Pat. No. 4,597,608 to LaVern N. Duffy describes an automobile windshield cover that prevents frost, ice or snow from freezing on a windshield which includes a shield portion formed of an elongated strip of pliable material, with at least one resilient strap on each end for attaching the shield portion to the automobile.

U.S. Pat. No. 4,848,825 to Clyde Niernberger describes an automobile windshield cover to prevent frost, ice or snow from freezing on a windshield, which includes a foldable, in accordion style, rectangular piece of material having a top edge and a bottom edge and trapezoidal shaped elements secured to the sides.

U.S. Pat. No. 5,356,191 to Dan Sheehan describes a protective cover for the windshield of an automobile which has a pair of flaps that extend from a center cover section. The flaps each have suction cups that secure the cover to the vehicle.

U.S. Pat. No. 6,598,653 to Joe B. Gonzalez describes a windshield covering system which includes a flexible panel having a handle assembly and a storage container for storing the panel and handle assembly.

None of these prior art references describe the present invention.

### SUMMARY OF THE INVENTION

It is an object of the present invention to provide an improved protective covering device designed to encompass a windshield and held in place via durable elastic fasteners secured to the vehicle's side mirrors.

### BRIEF DESCRIPTION OF THE DRAWINGS

FIG. 1 is a front perspective view of the device of the present invention secured in place on an automobile.

FIG. 2 is a front perspective view of the device of the present invention.

FIG. 3 is a close up perspective view of the device of the present invention attached to the side mirror of n automobile showing the attachment means.

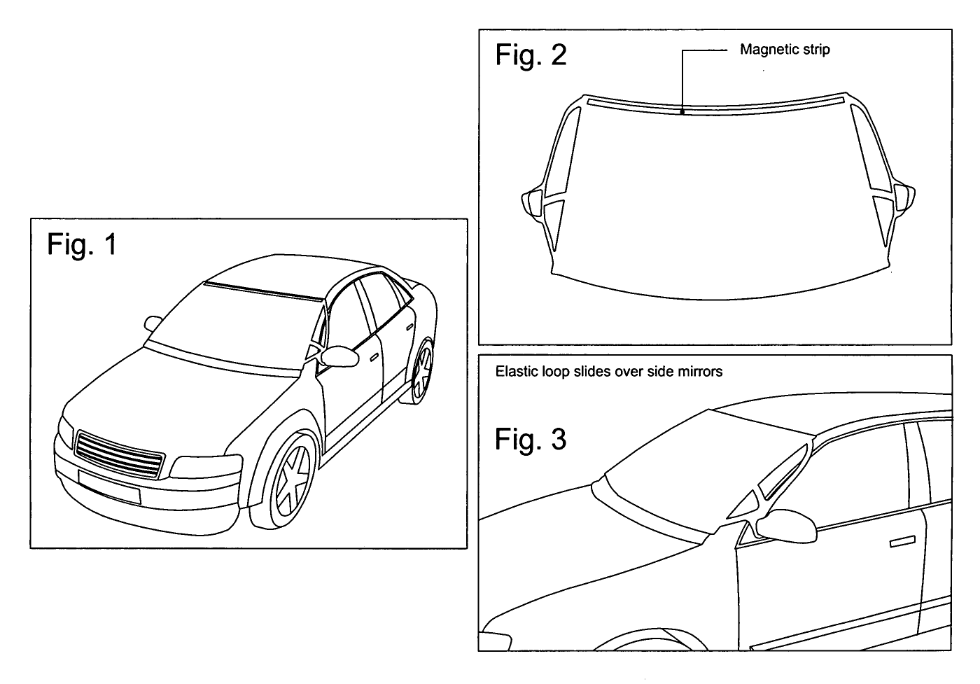

### DETAILED DESCRIPTION OF THE INVENTION

Everyday, millions of consumers climb into their automobiles and head off for a day of work, school, or recreation. Whether a busy executive traveling to an important business luncheon, a homemaker dropping the kids off at a school dance, or a professional delivery man making his rounds, automobiles offer consumers a simple and efficient means of traveling from one destination to the next. During the winter months, driving one's car usually first involves scraping the vehicle windshield and windows of accumulated frost, ice or snow. This task is particularly common for the millions of consumers who live in apartments, condominiums, mobile homes or houses which lack a covered garage, carport or similar sheltered area in which to park their vehicle. Further, parking one's car in the open air even for a few hours while one works, shops at the store or when visiting friends can result in the vehicle being covered in a thick blanket of ice or snow. Unfortunately, cleaning a vehicle of this debris is a difficult and time consuming task. Requiring the driver to stand in the frigid air as they lean over their vehicle in an attempt to remove the snowy buildup, manually scraping icy residue from a vehicle, results in the driver becoming wet, cold and disheveled.

The present invention, hereinafter referred to as the Ice Guard, is a unique invention which provides vehicle owners a simple means of preventing frost, ice or snow from accumulating on their vehicle windshield. The Ice Guard is a specially designed protective covering configured specifically to encompass the entire front windshield or rear window of a vehicle, thus protecting these areas from the elements. Generally rectangular in shape and gently contoured for a custom fit, the Ice Guard is designed to encompass the windshield completely, thus effectively preventing the accumulation of frost, ice or snow. The Ice Guard is produced in a range of sizes appropriate for the various makes and model vehicles on the market. It is manufactured from material which resists degradation from sun, ozone and weather and performs well in contact with oils and many chemicals and also remains useful over a wide temperature range, including extreme cold and displays outstanding physical toughness.

The Ice Guard is designed to rest flush against the vehicle windshield, encompassing the windshield completely. This is achieved by incorporating adjustable, looped elastic fasteners on each side of the unit to be secured over the vehicle side mirrors. A series of small magnetic fasteners also run the perimeter of the unit which secure the device flush against the windshield trim. To facilitate ease of use and storage, the Ice Guard is designed to be rolled into a compact roll between uses. An alternative embodiment includes an elastic, looped fastener for sale with the Ice Guard for use in binding the roll securely closed. A cylindrical shaped carrying case is also provided for use in storing the unit. The Ice Guard is manufactured in a range of attractive colors, as well as in neutral black or white.

Application and use of the Ice Guard is very simple and straight forward. A one step application, the user simply unrolls the Ice Guard, spreading the unit flat across their windshield. Next, the user simply anchors the device in place, via the elastic fasteners, to the vehicle side mirrors. Alternately, the user anchors the Ice Guard by way of the magnetic fasteners spaced evenly about the perimeter of the unit. Once installed, the user simply leaves the Ice Guard in place, allowing the Ice Guard to protect the windshield and side windows from external elements such as snow, ice and frost. In order to remove the Ice Guard, the user simply grasps the device by one looped holder, pulling the unit and accumulated snow, frost or sleet off the windshield where the snowy debris is dumped onto the ground below. The user then simply rolls the Ice Guard into a tight roll, storing the device away in the vehicle trunk, or if desired in the back seat.

The Ice Guard is a practical invention which provides consumers a number of significant benefits and advantages. Foremost, the Ice Guard provides the owners and operators of motor vehicles a simple and efficient means of protecting their car's windshield and side mirrors from exposure to the elements, particularly during the winter months. Preventing frost, snow and ice from accumulating on the windshield, rear window and side windows, use of the Ice Guard spares the consumer the time consuming hassle of scraping this debris from the car before embarking on a road trip. This advantage proves particularly beneficial to those consumers who live in homes without garages or covered carports. Eliminating the need to stand in the frigid winter air and rigorously scrape away frost, ice and snow from windshield and side mirrors, use of the Ice Guard enables consumers to embark for their destinations in a more timely manner. Allowing the user to simply remove the Ice Guard and go. Use of this cleverly designed protective covering also prevents the driver from becoming wet, cold and disheveled due to spending an extensive time outdoors in order to scrape their car. Universal in design, this handy covering is utilized with any make or model car, truck or SUV on the road. Easily applied and effortlessly removed, consumers will appreciate the ease and simplicity with which this product is utilized. Durably constructed of quality materials, the Ice Guard withstands season after season of continual use.

The Ice Guard is an innovative invention which provides consumers a simple and efficient means of preventing frost, snow and ice from accumulating on their vehicle windshield, rear window and side windows. Easily installed and durably constructed, this unique covering is a favorite commodity of any car owner. Affordably priced, the Ice Guard will be well received by vehicle owners and operators.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A protective windshield covering device, comprising: a generally rectangular contoured protective covering configured specifically to encompass the entire front windshield or rear window of a vehicle, thus protecting the windshield and back window from accumulating ice or snow.

2. The covering device of claim 1 wherein the covering comprises material which resists degradation from sun, ozone and weather and performs well in contact with oils and many chemicals and also remains useful over a wide temperature range, including extreme cold and displays outstanding physical toughness.

3. The covering of claim 1 wherein the covering is capable of being produced in a range of sizes appropriate for the various makes and model vehicles on the market.

4. The covering of claim 1 further comprising adjustable, looped elastic fasteners on both sides of the covering to be secured over the vehicle side mirrors to enhance a flush fit against the surface of a vehicle windshield.

5. The covering of claim 1 further comprising, a series of small magnetic fasteners along the perimeter of the covering to secure the covering flush against the windshield trim.

6. The covering of claim 1 further comprising the capability of being rolled into a compact roll between uses to facilitate ease of use and storage.

7. The covering of claim 6 further comprising an elastic, looped fastener for use in binding the roll securely closed.

8. The covering of claim 1 further comprising a cylindrical shaped carrying case for use in storing the covering.

9. The covering of claim 1 wherein the covering is capable of being manufactured in a range of attractive colors and neutral black or white.
